(19) United States
(12) Patent Application Publication
(10) Pub. No.: US 2024/0028780 A1
(43) Pub. Date: Jan. 25, 2024

(54) Secure Computerized Device

(71) Applicants: Luis Perez, Jersey City, NJ (US); Nitesh Anand, West New York, NJ (US)

(72) Inventors: Luis Perez, Jersey City, NJ (US); Nitesh Anand, West New York, NJ (US)

(21) Appl. No.: 17/870,157

(22) Filed: Jul. 21, 2022

(51) Int. Cl. G06F 21/86; G06F 21/32

(52) U.S. Cl. CPC G06F 21/86; G06F 21/32

(57) ABSTRACT

A secure computerized device such as a smartphone is provided. The secure device allows for disconnection of various components which are security sensitive, meaning that a remote unauthorized user may access the component without permission and record information about the device or its surroundings. Disconnection may be achieved through mechanical disconnection in some embodiments to prevent remote override, or may be a software based disconnection with additional security requirements to re-connect the component.

### BACKGROUND

### Technical Field

The present disclosure relates generally to computerized devices. More particularly the present disclosure relates to computerized device with mechanically disconnectable components to prevent remote access and control.

### Description of Related Art

Nearly all consumer electronic devices such as mobile telephones, tablets, personal computers, are connected to the internet via a wired and/or wireless (cellular, WiFi, Bluetooth® etc.) connection. Through this internet connection, these computerized devices are susceptible to hacking and other unauthorized remote access. Such access can allow unauthorized operation of device components, such as the microphone, speaker, camera, and so on, allowing surveillance and spying on people in their most private spaces.

While certain software implementations can deactivate the use of certain device components, if an external user has accessed the phone, the software restriction can be easily overridden. The only secure solution is a mechanical disconnection of a component from the device, such as a switch to cut power, or physical disconnection/removal from the device.

Therefore, what is needed is a computerized device which allows a mechanical disconnection of components for preventing unauthorized remote access to the components.

### SUMMARY

The subject matter of this application may involve, in some cases, interrelated products, alternative solutions to a particular problem, and/or a plurality of different uses of a single system or article.

In one aspect, a secure computerized device is provided. The device has a security-sensitive component attached to the computerized device. To prevent unauthorized remote access to the component, the component is mechanically disconnectable from the electronics system of the device. When mechanically disconnected, there is no way for a remote user to access it until a user with physical possession of the device mechanically re-connects the component. The secure computerized device further has a processor which is programmed to receive an access request of the security-sensitive component through a user interface. Upon receipt, the processor is programmed to send a query to determine if the security-sensitive component is connected or mechanically disconnected from the electronics system of the device. The processor is further operable to provide access to the security-sensitive component if the query determines that the security-sensitive component is connected to the electronics system of the device.

In another aspect, a secure computerized device is provided. The device has a security-sensitive component attached to the computerized device. This component is disconnectable from the electronics system of the device using a programming controlled by an input and a processor. The processor of the computerized device is programmed to receive the input as an access request of the security-sensitive component through a user interface. Upon receipt, the processor is programmed to send a query to determine if the security-sensitive component is allowed to be accessed through the user interface. The processor provides access through the user interface if allowed, and if not allowed, the processor initiates a two-factor authentication process through the user interface and if satisfied, the component can be accessed by the device user.

### BRIEF DESCRIPTION OF THE DRAWINGS

FIG. 1 provides a schematic view of an embodiment of mechanical connection and disconnection is shown.

FIG. 2A provides an embodiment of the computerized device such as a smartphone with a mechanically disconnectable component such as a camera.

FIG. 2B provides an embodiment of the computerized device such as a smartphone with a mechanically disconnectable component such as a camera.

FIG. 3A provides another embodiment of the present disclosure having a spring loaded “pop-in pop-out” disconnection mechanism to mechanically disconnect a component from the device.

FIG. 3B provides another embodiment of the present disclosure having a spring loaded “pop-in pop-out” disconnection mechanism to mechanically disconnect a component from the device.

FIG. 4A provides still another embodiment of the secure computerized device which has a push button release to cause the component to be spaced away from electronic contacts.

FIG. 4B provides still another embodiment of the secure computerized device which has a push button release to cause the component to be spaced away from electronic contacts.

FIG. 5 provides a flowchart of an embodiment of the present disclosure.

FIG. 6 provides an elevation view of another embodiment of the present disclosure.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a computerized device having components which are disconnectable, preferably mechanically, though which may be disconnected using a software implementation. While embodiments will be discussed herein with reference to a mobile cellular telephone, it should be understood that any computerized device falls within the scope of this disclosure, including but not limited to tablet computers, laptops, desktops, smart home devices, at the like. The term “mechanically disconnected” as used regarding the device refers to the disconnection of electric communication with the device such as by a switch which separates electric contact between device and the rest of the computerized system, a partial or full disconnection of the component from the device as a whole, and any other mechanical separation of a component from the device which deactivates the component. Mechanical disconnection is distinguished from a software-controlled deactivation or shut down of the component, which in some instances can be overridden remotely by remote control of the software of the device.

The security-sensitive components contemplated herein which can be disconnected from the device may include, but are not limited to a camera, speaker, microphone, GPS receiver, Bluetooth® transceiver, WiFi transceiver, Cellular transceiver, accelerometer, gyroscope, touchscreen, keyboard or other input source, and the like. Generally, disconnectable components are any components which could be remotely accessed by an unauthorized user to gather information about the device and/or its user and/or surroundings.

The computerized device of the present disclosure may achieve mechanical disconnection in any number of ways all of which are contemplated herein. In one embodiment, the component may be fully removable from the device. In such full removal embodiments, the device may allow for third party components to replace the original equipment manufacturer component. For example, a user may replace a stock camera on a smartphone with an enhanced, and/or brand name camera from a third-party camera supplier. In another embodiment, the component may be partially removable, such that it remains connected to the device but is mechanically disconnected from the electronic system of the device, thereby preventing its unauthorized use. In such an embodiment, the component may “pop” out and be slightly spaced away from the device via spring action. Pushing the component back in against the spring force returns it to an engaged position connected to the device. Partial and full removal embodiments may utilize various separation structures without straying from the scope of this disclosure. For example, a push-in push-out structure similar to a retractable pen may be used, a button or switch may release a catch and cause the component to be released, an L-shaped bracket may hold the component in place and can be slid laterally and then upwardly, the component may be friction-fit and movable against a force applied, and the like. In one embodiment, a lateral sliding toggle may release a catch against a spring force which allows removal of the component, either fully or paritally. In one embodiment, a rotatable cam which engages with a pin or other catch may be used to allow the push-in push-out structure as seen in certain retractable pens. In still another embodiment, a twist-lock structure may secure and release the component.

In still another embodiment, a manual switch accessible from outside of the device may be used to manually disconnect a component by manually separating electrical communication between the computerized device and the component. One switch may control one component, or a plurality of components. In one embodiment, one switch may operate to manually disconnect any component which could be used for unauthorized surveillance such as, but not limited to, camera, microphone, speaker, and location services component(s).

In some disconnectable embodiments having full or partial disconnection, as well as switch embodiments, the computerized device may include a waterproof or water-resistant component or components to allow the device to remain waterproof or water resistant even when the device has been mechanically disconnected. In one embodiment, a tight-fitting membrane, which may be a continuous material, fine mesh or fabric, and the like, may be positioned on the device side of a connector. In a further embodiment, a second tight-fitting membrane may be positioned on the mechanically disconnectable component. In switch embodiments, to the extent that the switch or button is on the outside of the computerized device, the switch (including buttons) may be equipped with a water-resistant layer sealing the switch about the device to limit or prevent water infiltration, allowing the device to be water-resistant or waterproof. Other water-resistance or waterproofing structures are contemplated herein and within the scope of this disclosure.

In other embodiments, secure deactivation of various device components, such as the components of a smartphone, may be done using a software-implemented control. In such an embodiment, a secondary identify confirmation ensures that the actual device user is accessing the component rather than an unauthorized remote user such as a hacker. This secondary identify confirmation may be achieved by two or multi-factor authentication. Authentication to activate the component such as a camera may include but is not limited to biometric confirmation such as facial ID, fingerprint ID, and the like, authentication code using an authenticator, RSA Token, USB/NFC key, text, telephone, or emailed code, and the like.

In still a further embodiment, the device may be programmed to use an artificial intelligence, machine learning, algorithm, or the like which can observer or estimate when it is likely or unlikely that a user may be using a certain component of the device. In a case where the computerized device programming determines that a component's use is unlikely, a two or multi-factor authentication may be required. For example, if a smartphone identifies through machine learning that a user commonly plays music and makes phone calls during the work day, it may allow access to the speaker and microphone without authentication, however if the microphone were to be activated in the middle of the night, a secondary authentication may be required. Similarly, if the smartphone's machine learning identifies that the camera is used typically in the evenings and on weekends, and not during the work week, it may require authentication for use during the work week and hours. This will effectively firewall the API call to the security-sensitive component until the user confirms they want to enable the component by using the two/multi-factor authentication as confirmation. Such embodiments may also be used in systems having links to a human-implanted device.

A further exemplary embodiment of the artificial intelligence, machine learning, or algorithm, that can observe or calculate a user or system action may be the following: a user opens a texting app, and a gyroscope on the smartphone detects the user is holding the phone in an approximately 90 degree angle, plus or minus 10 degrees, for three seconds. An AI, ML or an algorithm learns over time that whenever this sequence of events happens, the user is going to take a picture. Based on that learned/calculated behavior it makes an inference and attempts to enable the camera. Those API/Function calls to the operating system are then intercepted until confirmed “allow” or “deny” by the user.

Another example may be implemented when a user is driving. The phone's cellular signal is bouncing off different cell towers over a short period of time. When the user picks up the phone and swipes down, an AI, ML or an algorithm based on previous learned behavior infers that the user wants to turn on the GPS. Therefore, the computer may be programmed to opens a navigation program, and enables the GPS on phone and asks “where would you like to go?” The GPS enablement API/Function call is intercepted but requires authentication.

The confirmation step is a secondary authentication mechanism. For example, any calls to an Operating System API or function that enables the camera, GPS or other security sensitive component requires a secondary confirmation prior to the enablement of the mechanism.

In many embodiments, the operating system of the computerized device is operable to perform a confirmation check to a particular component prior to its operation to confirm the component is present, i.e. not mechanically or software disconnected. This requires additional programming beyond the typical operating system of an unsecured device.

In many embodiments, a combination of the mechanical disconnection of the component from the device electronic system, coupled with a software activation and/or coupled with a two or multi-factor authentication. For example, a user may mechanically disconnect a component such as a camera or microphone from the device. Upon mechanical reconnection, a two-factor authentication may be required to reactivate the component so it will operate normally.

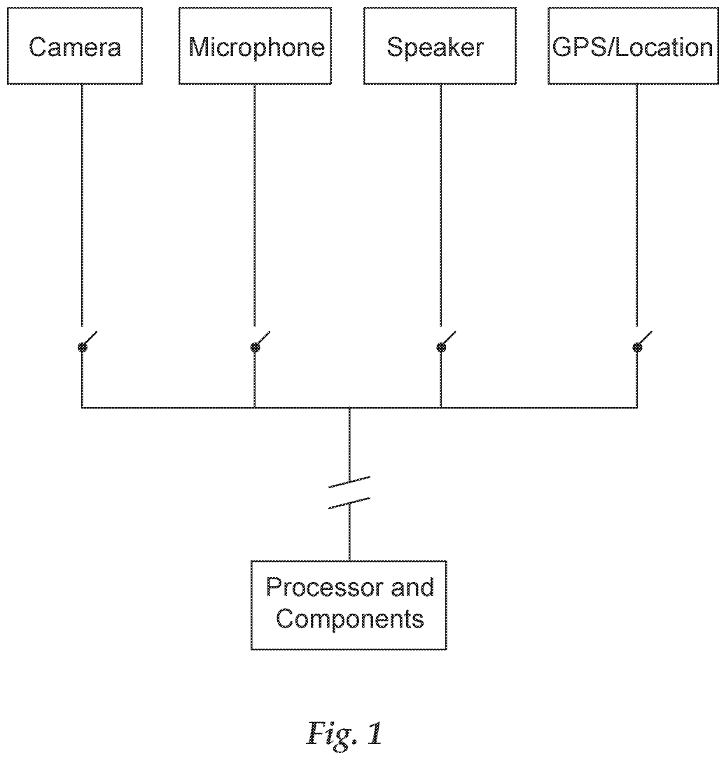

Turning now to FIG. 1 a schematic view of an embodiment of mechanical connection and disconnection is shown. Here, a switch allows for the mechanical disconnection of electronic communication with each component, the components being shown as a camera, microphone, speaker, and GPS and location services. Opening of the switch separates electrical contact between the component and the remainder of the device electronic system including communication with the processor and/or other components, and/or the battery or other power source. In various embodiments, the switch may be a single switch to control all components to be connected or disconnected, or one switch may be present for each component to be disconnected. In most embodiments, the switch may be a direct mechanical switch in that physical movement of the switch is physically linked to physical movement of the mechanical disconnection. This is compared to a switch which sends a signal to an actuator to disconnect the connection, which could conceivably be overridden by software control by an unauthorized user. While such a switch may be used in certain embodiments, the direct mechanical switch allows for more security with fewer options to override.

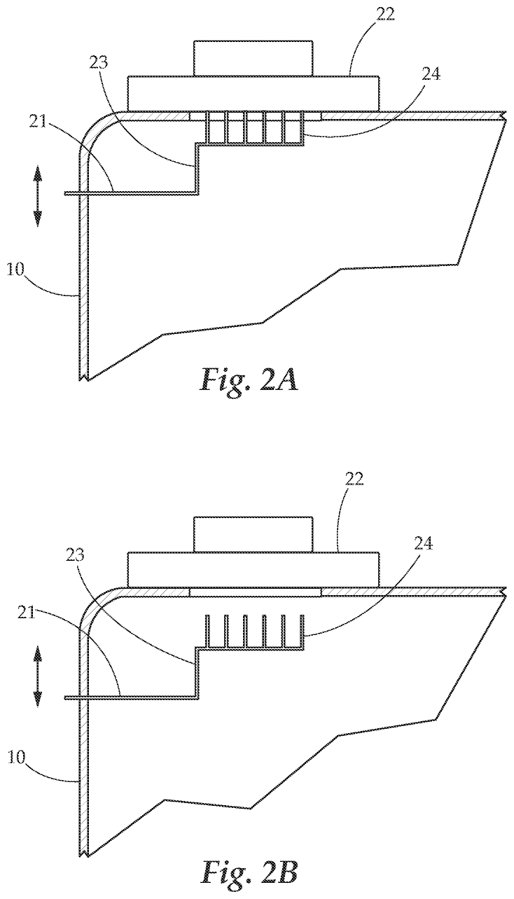

FIGS. 2A and B show an embodiment of the computerized device such as a smartphone with a mechanically disconnectable component such as a camera. FIG. 2A shows the camera component 22 connected to the electronics system of the smartphone 10 via contacts 24 in a connected mode. A switch 21 having a movable arm 23 extends through the smartphone 10 body and is in an engaged position such that electrical contacts 24 are connected to camera 22. Upon a disconnecting motion of switch 21, as seen in FIG. 2B, the camera 22 moves to a disconnected mode. The arm 23 moves the electrical contacts 24 away from the camera 22, thereby mechanically disconnecting the camera from the electronic system of the smartphone 10, creating a space 25 between contacts 24 and camera 22. While the component of the device 10 is shown as a camera in this view, it should be understood that in this embodiment and others, any other component may be similarly configured without straying from this invention. Non-limiting examples of other disconnectable components are disclosed above.

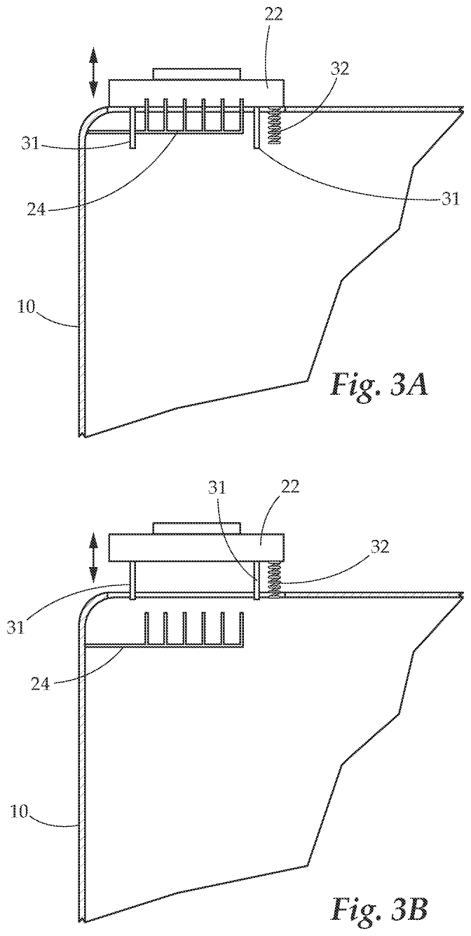

FIGS. 3A and 3B show a spring loaded “pop-in pop-out” disconnection mechanism to mechanically disconnect a component from the device. In FIG. 3A, a camera 22 is shown connected to the device 10 in a connected mode, as well as the device electronic system via electric contacts 24. A spring 32 is positioned within the device and engaged with the camera 22. A support bar 31 on each side of the camera 22 provides a moveable connection to allow the camera 22 to be spaced apart from the device body 10 while remaining connected to the device 10. Upon a downward pushing in of the camera 22 against the spring force, a catch is released or otherwise moved, allowing the camera 22 to extend away from the device body 10 as guided by support bars 31 and spring 32. This can be seen in FIG. 3B, whish shows the camera 22 spaced away from the device 10 in a disconnected mode but still connected to it by bars 31. Upon a pushing back in of the camera 22, it can be reconnected to the device electronic system once reengaged. When pushed back in a sufficient amount, a portion of the camera 22 and/or bars 31 will engage a catch or similar holding structure and remain connected until another push-in force is applied. It a similar embodiment, rather than the camera itself moving, the internal electric contacts may be recessed away from the camera within the device using a similar structure.

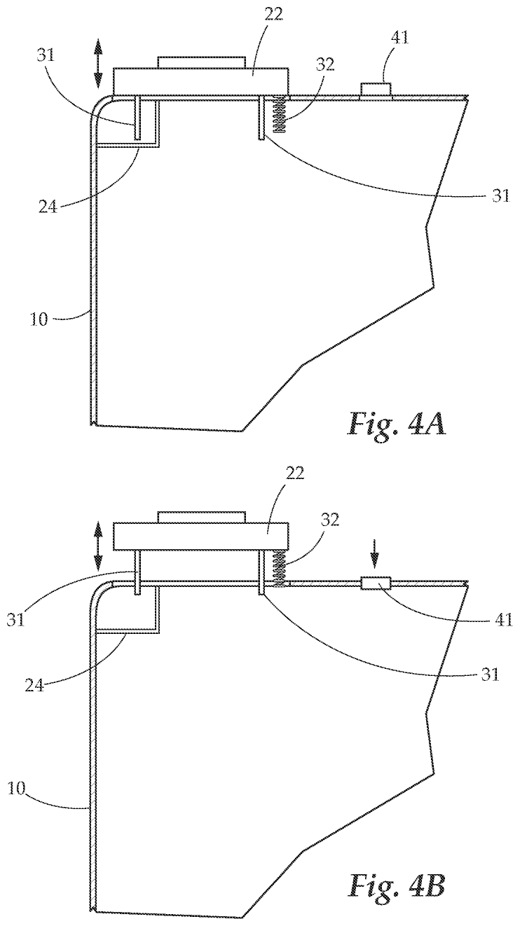

FIGS. 4A and 4B provide still another embodiment of the secure computerized device which has a push button release to cause the component to be spaced away from electronic contacts. Similarly, to the structure of FIGS. 3A and 3B, a camera 22 is shown connected to the device 10, as well as the device electronic system via electric contacts 24 in FIG. 4A. A spring 32 is positioned within the device and engaged with the camera 22. Support bars 31 allow camera 22 to move relative to the smartphone 10. FIG. 4A shows the camera 22 in a connected mode engaged with the electric contacts 24 and thus the electronic system of the smartphone 10. Upon a downward pushing of button 41, a catch or similar structure is released, allowing spring 32 to urge camera 22 upward and away from the smartphone 10 as guided and limited in motion by the support bar 31. FIG. 4B shows the disconnected mode of the camera 22 which is spaced apart from the smartphone 10 body. Upon a pushing of the camera 22 against spring force of spring 32, the camera 22 is moved back to its operational position connected to the smartphone 10 and electric contacts 24. The camera 22 will engage a catch or other holding structure and re-set the button 41 to a position that it can disconnect the camera 22.

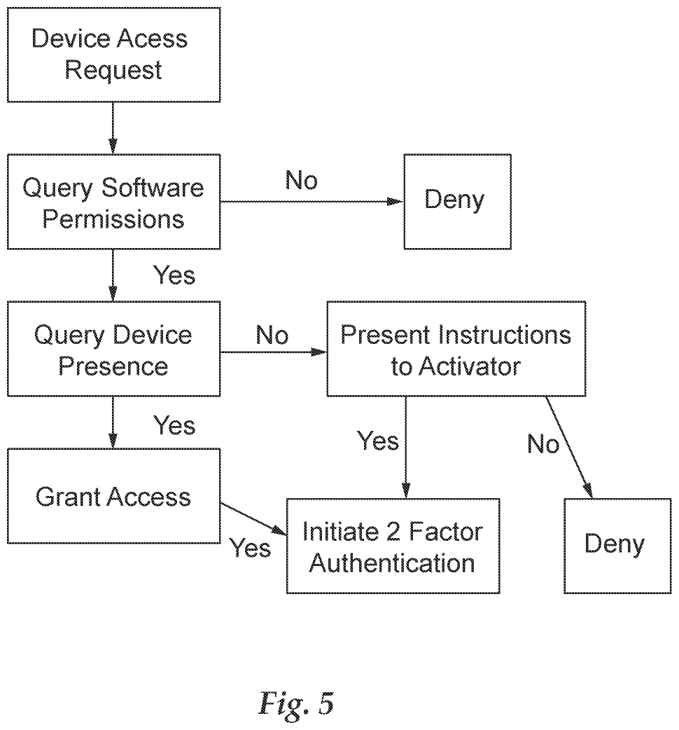

FIG. 5 provides a view of a flowchart which shows steps for the operating system of a computerized device to determine presence of a component via its accessibility to the computerized device. Initially, a user may provide an access request to a component, such as a camera, speaker, and the like through the user interface. The operating system sends a query to the software permissions first. If the software based permission is a “no” then the request is denied and access is not provided. If the software based permission is a “yes” the operating system is the programmed to query if the device is present, i.e. is it accessible electronically. If no, the system may present instructions to activate which may be done by flipping a switch, connecting the component, and the like to mechanically connect the component to the device. If the component is not connected within a predetermined time period, access may be denied. In this embodiment, once the component is activated by connecting it, a two or multi factor authentication is required. In other embodiments this authentication may be skipped. Once authenticated, the operating system grants access to the component and it can be used as intended.

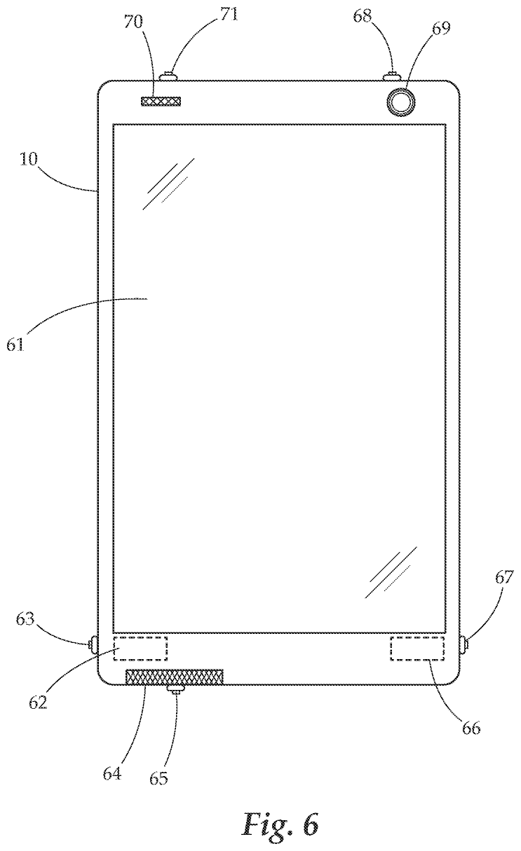

FIG. 6 provides a view of an embodiment of a smartphone having multiple different disconnectable components. As discussed above, the specific structures used to mechanically disconnect the component from the device, here shown as a smartphone, may vary within the scope of this disclosure, whether disconnectable via a switch, full disconnection or partial disconnection using a friction fit, spring loaded mechanism(s), and the like. In the embodiment shown, the smartphone device 10 has a number of components including screen 61, microphone 70, front facing camera 69, rear facing camera (not shown), GPS receiver 62, speaker 64, and a WiFi/Cellular transceiver 66 or similar communications components. Further in this view, the smartphone has a plurality of buttons accessible from its exterior. Button 71 causes a mechanical disconnection of the microphone 70. In the embodiment shown, the button 71 and other buttons of this embodiment operate as a switch to connect and disconnect the component by separating an electrical contact within the smartphone 10. Button 68 causes a mechanical disconnection of the camera 69. Button 63 causes a mechanical disconnection of GPS receiver 62. Button 65 causes a mechanical disconnection of speaker 64. Button 67 causes a mechanical disconnection of the signal transceiver 66. As discussed above, the device can be any computerized device with remote networked access that has components that could be susceptible to unauthorized use.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A secure computerized device comprising:
a security-sensitive component attached to the computerized device, the component being mechanically disconnectable from the electronics system of the device; and
a processor of the computerized device being programmed to receive an access request of the security-sensitive component through a user interface, the processor programmed to send a query to determine if the security-sensitive component is connected or mechanically disconnected from the electronics system, and the processor further operable to provide access to the security-sensitive component if the query determines that the security-sensitive component is connected to the electronics system of the device.

2. The secure computerized device of claim 1 wherein the security-sensitive component is fully removable from the device.

3. The secure computerized device of claim 1 wherein the security-sensitive component is partially disconnectable from the device such that it may be spaced apart from a body of the device to mechanically disconnect it from the device electronics system, while remaining connected preventing removal of the security-sensitive component.

4. The secure computerized device of claim 1 further comprising a switch, the switch operable to mechanically disconnect the security-sensitive component from the electronics system of the device.

5. The secure computerized device of claim 4 further comprising a spring in communication with the switch.

6. The secure computerized device of claim 3 further comprising a button on the device, the button operable to release a catch, the device comprising a spring engaged with the security-sensitive component, the spring urging the security-sensitive component away from the body of the device as guided by a support bar.

7. The secure computerized device of claim 3 wherein the security-sensitive component can be pushed inward to release a catch from a spring engaged with the security-sensitive component, the spring urging the security-sensitive component to an outward position away from the body of the device as guided by a support bar.

8. The secure computerized device of claim 7 wherein the security-sensitive component can be pushed from the outward position against the spring force to an operational position, the operational position causing the security-sensitive to engage the catch.

9. The secure computerized device of claim 1 wherein the computerized device is a smartphone.

10. The secure computerized device of claim 1 wherein the processor is operable to require a two-factor authentication upon a reconnection of the security-sensitive device from a disconnected mode.

11. The secure computerized device of claim 1 wherein the security-sensitive component is at least one of a camera, a speaker, a microphone, a GPS receiver, a cellular transceiver, a WiFi transceiver, a Bluetooth® transceiver, an accelerometer, a gyroscope, a touchscreen, and a keyboard.

12. The secure computerized device of claim 1 wherein the security-sensitive component is fully removable from the device and comprising a spring-loaded slider, a movement of the slider retracting a catch engaged with the security-sensitive component allowing removal of the component.

13. A secure computerized device comprising:
a security-sensitive component attached to the computerized device, the component being disconnectable from the electronics system of the device using a programming controlled by an input and a processor; and
the processor of the computerized device being programmed to receive an access request of the security-sensitive component through a user interface, the processor programmed to send a query to determine if the security-sensitive component is allowed to be accessed through the user interface, the processor allowing access through the user interface if allowed, and if not allowed, the processor requiring a two-factor authentication through the user interface.

14. The secure computerized device of claim 13 wherein the two-factor authentication is a biometric identifier.

15. The secure computerized device of claim 13 wherein the two-factor authentication is a code entry requirement through the user interface.

16. The secure computerized device of claim 13 wherein the processor is configured to track conditions of device use corresponding to activation of the security-sensitive component and recording the condition in a memory, the processor further operable to require a two-factor authentication upon an input request to the security-sensitive component if the conditions of the device are different from a previously recorded condition.

17. The secure computerized device of claim 16 wherein the processor is configured to track conditions using data gathered from at least one of an accelerometer, cellular transceiver, GPS receiver, clock, and touch screen interface.

18. The secure computerized device of claim 13 wherein the security-sensitive component can be mechanically disconnected from the device.

19. The secure computerized device of claim 18 wherein the security-sensitive component is fully removable from the device.

20. The secure computerized device of claim 18 wherein the security-sensitive component is partially disconnectable from the device such that it may be spaced apart from a body of the device to mechanically disconnect it from the device electronics system, while remaining connected preventing removal of the security-sensitive component.
